(19) United States
(12) Patent Application Publication
(10) Pub. No.: US 2026/0134411 A1
(43) Pub. Date: May 14, 2026

(54) A SYSTEM AND METHOD OF A BLOCKCHAIN PAYMENT INTERFACE FOR PERFORMING TRANSACTION INVOLVING DIFFERENT CURRENCIES

(71) Applicant: Venusai Chodisetti, Bangalore (IN)

(72) Inventor: Venusai Chodisetti, Bangalore (IN)

(21) Appl. No.: 19/119,584

(22) PCT Filed: Oct. 12, 2023
(86) PCT No.: PCT/IB2023/060271

§ 371 Date: Apr. 9, 2025

(30) Foreign Application Priority Data
Oct. 12, 2022 (IN) 202241058271

(51) Int. Cl. G06Q 20/10; G06Q 20/06; G06Q 20/36; G06Q 20/38; G06Q 20/40

(52) U.S. Cl. CPC G06Q 20/10; G06Q 20/065; G06Q 20/36; G06Q 20/381; G06Q 20/401; G06Q 2220/00

(57) ABSTRACT

The present disclosure provides a payment interface for performing a transaction involving different currencies. The method includes the steps of registering a sender profile in a payment interface and generating a unique ID number by a sender device, then generating a request for transferring a pre-defined type of currency of the value from the sender profile to a receiver account. Then, details of the receiver account are verified and a stable BPI form is created, for storing data in a blockchain, by a server. Then, converting the value in the stable BPI form to digital currency based on the pre-defined type of currency of the value, using blockchain and transferring the value stored in the stable BPI form to a bank account and/or crypto wallet of the receiver by converting the digital currency to the pre-defined type of currency of the value, by the server.

### FIELD

The embodiments herein generally relate to a system and method of a blockchain payment interface for facilitating a transaction involving different currencies. More particularly, the disclosure relates to a system and method for performing faster transfer of fiat currencies between different countries.

### BACKGROUND AND PRIOR ART

Currency is a legal tender specific to one or more countries, wherein the value of every currency varies from country to country. Transferring a currency from one country to another can be performed by conversion of the currency to the currency of the other country, based on an exchange value.

Currently, there are various systems for enabling transfer of currencies from one country to another. SWIFT is one of the payment systems including a network of banks in multiple countries, for facilitating transaction of different currencies between different countries. However, SWIFT transfers are time-consuming as they require more than 48 hours for transferring currencies between various banks, and involve a huge amount of processing and transaction fees, thereby lacking economic feasibility for transferring smaller amounts.

Further, for matching with the increasing needs for cross-medium currency transactions, the existing currency exchange modes lack technical transparency, accessibility, quicker transactions and feasible transaction fees.

Also, performing instant transaction between different currencies requires a secured and advanced mode capable of facilitating a fixed value to be transmitted that is unaffected by constant change in the exchange rates. Also, the various existing system do not facilitate transfer of currencies between different countries without significant additional charge and duration.

Therefore, there is a need for facilitating faster and instant transaction of different currencies between different countries. Moreover, there is a need for a transparent and secured system and method facilitating instant online transaction of different currencies between different countries.

### OBJECTS

Some of the objects of the present disclosure are described herein below:
The main objective of the present disclosure is to provide a system and method of a blockchain payment interface for facilitating a transaction involving different currencies.

Another objective of the present disclosure is to provide a system and method for performing instant transaction from one currency to another currency.

Still another objective of the present disclosure is to provide a system and method of a secured system and method of transferring fiat currency between different countries using block-chain.

Yet another objective of the present disclosure is to provide a faster and economical system and method of performing transactions involving different currencies between different countries.

The other objectives and advantages of the present disclosure will be apparent from the following description when read in conjunction with the accompanying drawings, which are incorporated for illustration of preferred embodiments of the present disclosure and are not intended to limit the scope thereof.

### SUMMARY

In view of the foregoing, an embodiment herein provides a system and method of performing transaction involving different currencies.

In accordance with an embodiment, the system includes but not limited to a plurality of sender devices, a plurality of receiver devices, a server and a communication network. In an embodiment, the sender accesses the sender device for performing the transaction for transferring a value in a first currency to a receiver. In an embodiment, the receiver accesses the receiver device for receiving the value of transaction in a second currency.

In an embodiment, the plurality of sender devices and the plurality of receiver devices are connected to the server through the communication network.

In an embodiment, the sender device can include a processor for initiating a request for a transfer of a value in a first currency from a sender profile to a receiver account in a second currency. The sender device can initiate the transfer of the value on verifying details of the receiver account. The sender device is connected to the server which includes a processor, wherein the server device connects the initiated transfer to a blockchain network. The server performs a contract based determination of converting the value in the first currency to a value in the second currency for obtaining a receiver value, and to a value in the crypto currency for obtaining a crypto value, and recording the receiver value and the crypto value. An input converting unit is provided in the processor of the server for converting the value in the first currency to the crypto value in the crypto currency. A stable BPI form creation is provided in the server for recording details of sender, details of receiver, first currency, second currency, first exchange rate, second exchange rate, value for transfer, and receiver value in a block to create a stable BPI form. An output converter unit in the server adjusts the crypto value to the receiver value recorded in the stable BPI form by comparing a third exchange rate between the crypto currency and the second currency. A receiver device is connected to the server for receiving the receiver value as one of cryptocurrency in a receiver crypto wallet and second currency in a receiver bank account.

In accordance with an embodiment, the method includes the following steps. First, linking a sender profile registered in an interface to a bank account of the sender, and a wallet set up by the interface, by a processor of a sender device. Then, initiating a request for a transfer of a value in a first currency from the sender profile to a second currency in a receiver account, by the processor of the sender device. Next, verifying details of the receiver account for processing the request for the transfer, by a processor of a server. Then, initiating the transfer of the value from the sender profile to the receiver account through a payment gateway, by the processor of the server. Next, connecting the payment gateway for the initiated payment to a blockchain network for processing the request, by the processor of the server. Then, performing determination of a conversion of the value to the second currency for obtaining a receiver value, and conversion to the crypto currency obtaining a crypto value, and recording the receiver value and the crypto value, by the processor of the server. The conversion is determined based on extracting a first exchange rate for converting the first currency to the second currency, and a second exchange rate for converting the first currency to the cryptocurrency, by the processor of the server. Next, converting the value in the first currency received through the payment to the crypto value in the crypto currency, by an input converting unit in the processor of the server. Then, recording details of sender, details of receiver, first currency, second currency, first exchange rate, second exchange rate, value for transfer, and receiver value in a block for creating a stable BPI form, by the processor of the server. Next, performing routing and queue determination for initiating a transfer of the crypto value to the receiver account, by the processor of the server. Then, adjusting the crypto value to the receiver value recorded in the stable BPI form by comparing a third exchange rate between the crypto currency and the second currency, by an output converter unit in the processor of the server. Finally, transmitting the receiver value in one of cryptocurrency and second currency to the receiver account, by the processor of the server.

In an embodiment, the first currency can include a fiat currency in the country of the sender and the second currency can include a fiat currency in the country of the receiver.

In an embodiment, the server extracting the first exchange rate and the second exchange rate at a time of start of the day of the transaction. In an embodiment, the first currency and the second currency pre-defined by the sender in the interface, using the processor of the sender device.

In accordance with an embodiment, the server connected to an internal fund account including a balance for performing transaction involving crypto currency. The internal fund account facilitates adjusting the crypto value to the receiver value based on the third exchange rate at that time.

In an embodiment, the crypto value that is equal to the receiver value converted to the receiver value in the second currency, and transmitted to the receiver account.

In an embodiment, the method includes extracting the first exchange rate and the second exchange rate on initiation of the request, by the processor of the sender device, and transmitting a notification including the first exchange rate and the second exchange rate to the sender profile for receiving confirmation of performing the transfer of the value.

In an embodiment, details of the initiation of the request including value in a first currency, sender profile, second currency, receiver account stored in a payment database, and the payment database is connected to an operation database, wherein the operation database connected to the blockchain network.

In an embodiment, details of the wallet of the sender profile including sender details, balance stored in a blockchain sender database, and the blockchain sender database is connected to an operation database, wherein the operation database is connected to the blockchain network.

In another embodiment, a method for performing a transaction involving different currencies, can comprise the following steps. First, linking a sender profile registered in an interface to a bank account of the sender, and a wallet set up by the interface, by a processor of a sender device. Then, initiating a request for a transfer of a value in a first digital currency from the sender profile to a second currency in a receiver account, by the processor of the sender device. Then, verifying details of the receiver account for processing the request for the transfer, by a processor of a server. Next, initiating the transfer of the first digital currency through a blockchain network for processing the request, by the processor of the server. Then, performing determination of a conversion of the value to the second currency for obtaining a receiver value, and recording the receiver value, by the processor of the server. The conversion can be determined based on extracting a fourth exchange rate for converting the first digital currency to the second currency, by the processor of the server. Next, recording details of sender, details of receiver, first digital currency, second currency, fourth exchange rate, value for transfer, and receiver value in a block for creating a stable BPI form, by the processor of the server. Then, performing routing and queue determination for initiating a transfer of the value to the receiver account, by the processor of the server. Next, adjusting the value to the receiver value recorded in the stable BPI form by comparing the fourth exchange rate between the crypto currency and the second currency at that time, by an output converter unit in the processor of the server. Finally, transmitting an amount equal to the receiver value in one of cryptocurrency and/or second currency to the receiver account, by the processor of the server.

In an embodiment, the first digital currency can include a crypto currency and the second currency can include a fiat currency in the country of the receiver.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a block diagram of a sender device of a system of performing a transaction involving different currencies, according to an embodiment herein;

FIG. 2 illustrates a block diagram of a server of a system of performing a transaction involving different currencies, according to an embodiment herein;

FIG. 3 illustrates a block diagram of the system of performing a transaction involving different currencies, according to an embodiment herein;

FIG. 4 illustrates a flow chart of a method of performing a transaction involving different currencies, according to an embodiment herein;

FIG. 5a illustrates a detailed flow chart of the method of performing a transaction involving different currencies, according to an embodiment herein;

FIG. 5b illustrates a flow chart of a method of performing a recharge of a wallet of the sender profile, according to an embodiment herein;

FIG. 6a illustrates a stable BPI form created in the blockchain network, according to an embodiment herein; and

FIG. 6b illustrates a plurality of table in the operation database of the blockchain network, according to an embodiment herein.

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

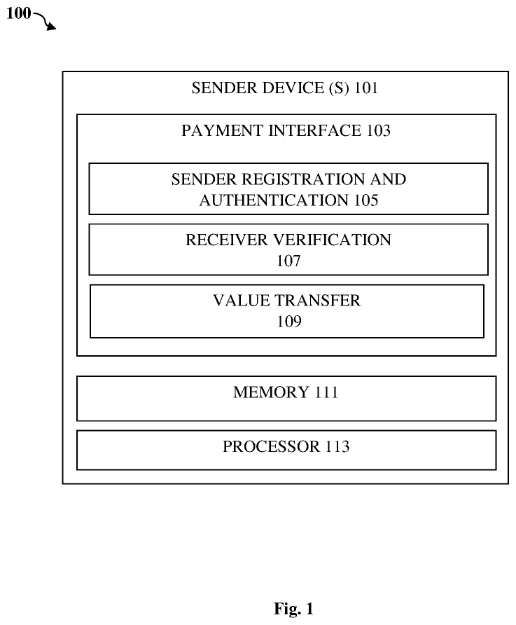

As mentioned above, there is a need for facilitating faster and instant transaction of different currencies between different countries. In particular, there is a need for a transparent and secured system and method facilitating instant online transaction of different currencies between different countries. The embodiments herein achieve this by providing “A system and method of a blockchain payment interface for performing transactions involving different currencies”. Referring now to the drawings, and more particularly to FIG. 1 through FIG. 6b, where similar reference characters denote corresponding features consistently throughout the figures, there are shown preferred embodiments.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art.

The systems described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

Blockchain is a technology for storing data. The data in a blockchain is stored in a plurality of blocks, wherein the blocks are linked to each other. A blockchain network is a network of a plurality of communication devices including a computer or laptop or a mobile phone. Each communication device is a node, wherein the plurality of nodes is connected to each other through internet. The nodes broadcast information, relay information and store the information in a new block in a blockchain for ensuring immutability and transparency of data.

FIG. 1 illustrates a block diagram of a sender device of a system of performing a transaction involving different currencies. In an embodiment, the sender device 101 is accessed by a sender for performing the transaction. In an embodiment, the sender can include but not limited to a user using the payment interface 103 for transferring a value in a first currency to another account.

The sender accesses a blockchain payment interface 103 (hereinafter referred to as a payment interface) using the sender device 101 for performing the transaction. In an embodiment, the sender device 101 includes a memory 107 and a processor 109. The memory 107 in the sender device 101 can be configured for storing instructions for performing the transactions. The processor 109 in the sender device 101 can be configured for executing the stored instructions for performing the transaction.

In an embodiment, the sender registration and authentication 105 can be configured for registering a sender in a value transfer engine and authenticating the registered sender. For the registration, the sender can access the payment interface 103 in the sender device 101 for transmitting details of the sender, wherein the details can include but not limited to name, phone number, address and government authorized document number, for example Aadhaar number, PAN number etc.

Then, the sender registration and authentication 105 can be configured for verifying the details received from the sender. On verifying the details, the sender registration and authentication prompts the sender requesting bank account details and/or crypto-wallet details. The sender registration and authentication 105 can be configured to create a sender profile, including a user name and password, in the value transfer engine based on the details of the sender, bank account details and/or crypto-wallet details. The sender registration and authentication 105 can be configured for creating a wallet in the value transfer engine by linking with the bank account of the sender profile and/or crypto wallet of the sender profile.

In an embodiment, on creating the wallet, the sender registration and authentication can be configured for generating a unique ID for the sender profile. In an embodiment, the unique ID is linked to the wallet, the bank account and/or the crypto-wallet associated with the sender profile.

In an embodiment, the sender can use the payment interface 103 for transferring a first currency from the bank account to the wallet and/or transferring tokens of a digital currency from the crypto-wallet to the wallet. The first currency is the legal tender in the country of the sender.

In an embodiment, the unique ID is configured for debiting and transferring a value from the wallet, bank account and/or crypto-wallet associated with the sender profile. In an embodiment, the value can include one of the first currency and digital currency.

In an embodiment, the sender registration and authentication 205 can be configured for facilitating the registered sender to access the value transfer engine 203, wherein the registered sender is authenticated based on details of the sender profile including username and password.

In an embodiment, the receiver verification 207 can be configured for verifying details of the receiver submitted by the sender profile for transferring the value. In an embodiment, the receiver can include but not limited to a user receiving the value from the transaction performed by the sender In an embodiment, the details of the receiver including name of receiver, phone number of receiver, authorized government document of the receiver, bank account details of the receiver and crypto-wallet of the receiver.

On verifying the details of the receiver, the value transfer 109 is configured for receiving a request for transferring a value to the receiver account, from the sender profile. In an embodiment, the sender can pre-define a type of currency of the value for transferring to the receiver. In an embodiment, the type can include one of fiat currency and digital currency.

The value of transfer is deducted from one of wallet associated with the sender profile, bank account linked to the sender profile and/or crypto-wallet linked to the sender profile based on the pre-defined type of currency of the value. In an embodiment, the value transfer 109 determines transferring the value from one of the wallet, bank account and/or crypto-wallet associated with the sender profile based on the pre-defined type of the value.

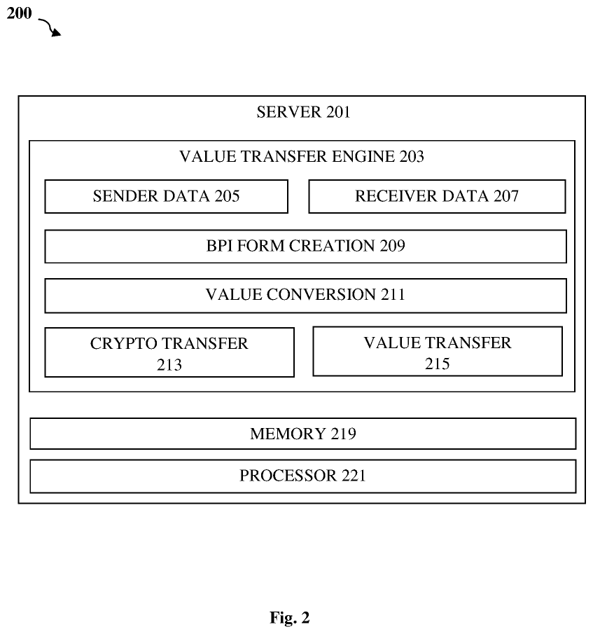

FIG. 2 illustrates a block diagram of a server of a system for performing a transaction involving different currencies. In an embodiment, the payment interface 103 is connected to the server 201 for performing the transaction of transferring a value from the sender to the receiver. In an embodiment, the server 201 can include but limited to a value transfer engine 203, processor 221 and a memory 219. In an embodiment, the memory 219 can be configured for storing instructions for performing the transaction between the sender and the receiver. In an embodiment, the processor 221 can be configured for executing the stored instructions for performing the transaction between the sender and the receiver.

In an embodiment, the value transfer engine 203 is configured for performing transaction between the sender and the receiver. The value transfer engine 203 includes a sender data 205, receiver data 207, a stable BPI form creation 209, a value conversion 211, a value transfer 213, processor 221 and a memory 219.

In an embodiment, the sender data 205 can be configured for receiving details of the sender profiles for performing the transaction. In an embodiment, the receiver data 207 can be configured for receiving details of the receiver account associated with the sender profile for performing the transaction.

In an embodiment, the stable BPI form creation 209 can be configured for generating a Banking Payment Instruction form (hereinafter referred to as BPI form) for a transaction based on the receiver account details and value of transfer, received from the blockchain payment interface 103. The stable BPI form is generated using blockchain for performing the transaction. The stable BPI form is generated by blockchain in a format compatible with the type of currency of the value to be transferred to the receiver and country of the receiver. In an embodiment, the format including but not limited to txp etc. In an embodiment, the type of currency of the value including one of the fiat currency and digital currency. The fiat currency can vary based on country of the receiver. In an embodiment, the stable BPI form is configured in the blockchain for maintaining the value of transfer for overcoming fluctuations in exchange price of different currencies and/or digital currency.

In an embodiment, the stable BPI form configured by blockchain can include but not limited to value of the transfer, bank account number of the receiver and/or crypto-wallet of the receiver, name of the receiver, code associated for online transfer (For example IFSC, etc) for receiving the value of transaction.

The value conversion 211 can be configured for determining an amount of digital currency corresponding to the value of transaction and converting the value to the determined amount of digital currency. In an embodiment, the value conversion 211 can be configured for determining a number of tokens of the digital currency based on an exchange value for the type of value of transaction stored in the stable BPI form. The exchange value is between the type of the value of fiat currency sent by the sender and the digital currency. The digital currency can include but not limited to crypto-currency.

In an embodiment, the crypto transfer 213 can be configured for transferring the converted digital currency to a crypto wallet associated with the receiver, when the pre-defined type of currency of the value to be transferred is digital currency. In an embodiment, the crypto transfer 213 can be configured for transferring the digital currency using block chain.

In an embodiment, the value conversion 211 can be configured for converting the digital currency to the fiat currency for transferring to the receiver, when the pre-defined type of currency of the value to be transferred is fiat currency, The value conversion can determine an amount of second currency corresponding to the value of transfer stored in the stable BPI form based on an exchange value between the first currency and the second currency during the time at start of the day of creation of the stable BPI form. The value conversion 211 converts the digital currency to the second currency.

In an embodiment, the value transfer 217 can be configured for transferring the converted second currency from the blockchain to the receiver bank account based on the details provided in the stable BPI form.

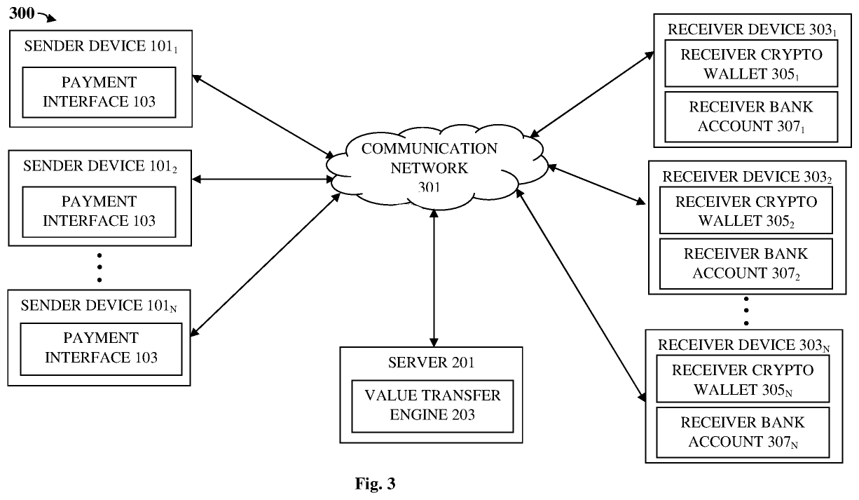

FIG. 3 illustrates a system of performing a transaction involving different currencies. In an embodiment, the system includes a plurality of sender devices 101, a plurality of receiver devices 303, a server 201 and a communication network 301. In an embodiment, the receiver accesses the receiver device 303 for receiving the value of transaction performed by the sender. The receiver can access the receiver crypto wallet 305 and the receiver bank account 307, using the receiver device 303 for receiving the value of transaction transferred by the sender.

In an embodiment, the plurality of sender devices 101 is connected to the value transfer engine 203 of the server 201 through the communication network 301. In an embodiment, the communication network 301 can include but not limited to internet. In an embodiment, the server is connected to the receiver crypto wallet 305 and the receiver bank account 305 through the communication network 301.

In an embodiment, the sender device 101 can include but not limited to a mobile phone, laptop, any electronic communication device. In an embodiment, the receiver device 303 can include but not limited to a mobile phone, laptop, any electronic communication device.

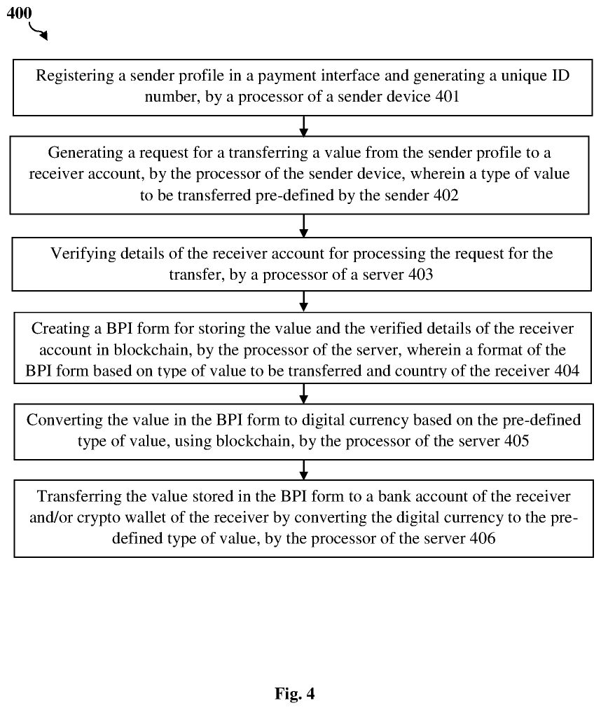

FIG. 4 illustrates a method of performing a transaction involving different currencies. In an embodiment, the method includes but not limited to the following steps. First, registering 401 a sender profile in a blockchain payment interface and generating a unique ID number, by a processor of a sender device. Next, generating 402 a request for a transfer of a value from the sender profile to a receiver account, wherein a type of currency of the value to be transferred pre-defined by the sender by the processor of the sender device. The value of transfer is deducted from the wallet associated with the sender profile, bank account linked to the sender profile and/or crypto-wallet linked to the sender profile.

Then, verifying 403 details of the receiver account for processing the request for the transfer, by a processor of a server.

Next, creating 404 a stable BPI form for storing the value and the verified details of the receiver account in blockchain, by the processor of the server, wherein a format of the stable BPI form based on type of currency of the value to be transferred and country of the receiver. Then, converting 405 the value in the stable BPI form to digital currency based on the pre-defined type of currency of the value, using blockchain, by the processor of the server. Next, transferring 406 the value stored in the stable BPI form to a bank account of the receiver and/or crypto wallet of the receiver by converting the digital currency to the pre-defined type of currency of the value, by the processor of the server. In an embodiment, the digital currency is directly transferred to crypto-wallet of the receiver, when the pre-defined type of currency of the value is digital currency. In an embodiment, the digital currency is converted to the fiat currency of the receiver based on the value stored in the stable BPI form and transferred to the bank account of the receiver.

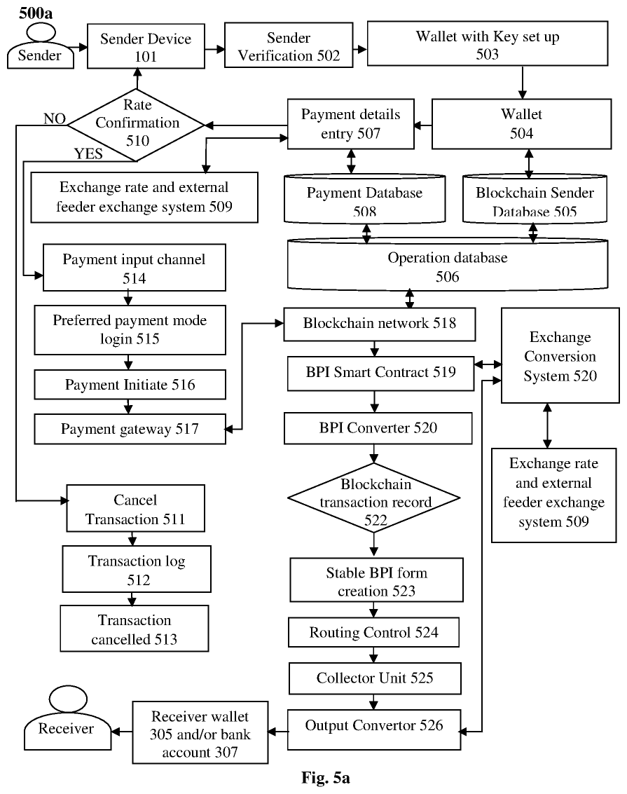

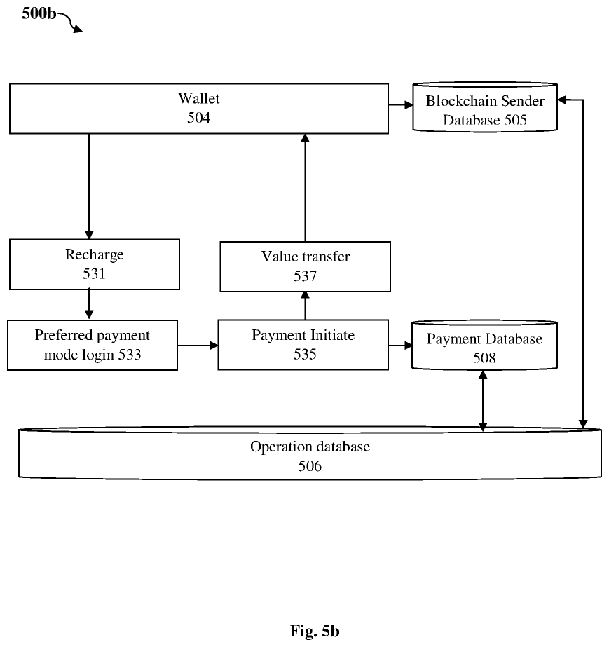

FIG. 5a illustrates a detailed flow chart of the method of performing a transaction involving different currencies. In an embodiment, the sender can access the payment interface 101 using the sender device 101. The payment interface 101 can perform sender verification 502 based on details of the sender for registering a sender profile. A wallet with a public key and a private key is set up 503 for the verified sender in the payment interface 103. In an embodiment, a bank account of the sender can be linked to the wallet. The wallet 504 can store crypto-currency and/or fiat currency received from the account linked to the wallet. In an embodiment, the created wallet can be stored in a blockchain sender database 505.

In an embodiment, the blockchain sender database 505 can store data of wallets of plurality of sender profiles and transmit the data to an operation database 506. In an embodiment, the operation database 506 can be linked to a blockchain network 518 of the payment interface 103.

In an embodiment, the sender including a sender profile and a wallet 504 can initiate a request for transfer of a value by providing payment details entry 507. The payment details entry 507 can include a value for transfer in the first currency, receiver account, and the second currency. The data of payment details entry 507 of plurality of sender profiles can be stored in a payment database 508. In an embodiment, the payment database 508 can transmit the data of the plurality of sender profiles to the operation database 506.

In an embodiment, on receiving the payment details entry 507, a first exchange rate and a second exchange rate can be extracted from an exchange rate and external feeder exchange system 509. The first exchange rate can include an exchange rate for converting the first currency to the second currency. In an embodiment, the first currency can include a fiat currency in the country of the sender and the second currency can include a fiat currency in the country of the receiver.

The second exchange rate can include an exchange rate for converting the first currency to the crypto currency. The first exchange rate and the second exchange rate can be based on a time at a start of the day of the request for transfer. The obtained first exchange rate and the second exchange rate can be transmitted as a notification for rate confirmation 510 to the sender profile in the sender device. In an embodiment, the sender can determine confirming the transfer of value and/or cancelling the transfer of value based on the first exchange rate and the second exchange rate. On cancelling the transfer of value, the cancel of transaction is notified in the payment interface 103. A transaction log 512 is created and the transaction is cancelled 513.

On confirming the transfer of the value, the payment interface 103 can connect to an issue processor of a payment input channel 514. In an embodiment, the payment input channel can include a bank. Then, the issue processor can connect to a login page of a preferred payment mode 515. In an embodiment, the preferred payment mode can include but not limited to netbanking. Then, on logging in on the login page, the sender can be directed to initiating payment in an interface of the payment mode. The initiated payment can be connected to a payment gateway 517.

In an embodiment, the payment gateway 517 is connected to the blockchain network 518 of the payment interface 103. On receiving the value from the initiated payment, a contract-based determination is performed through a BPI smart contract 519.

In an embodiment, the BPI Smart Contract 519 can perform extraction of a first exchange rate and a second exchange rate from an exchange rate and external feeder exchange system 521. The exchange rate and external feeder exchange system 521 can include an external application of an official exchange of the first currency, the crypto currency and the second currency. The BPI Smart Contract 519 can connect to the exchange rate and external feeder exchange system 521 using APIs.

The extracted first exchange rate and the second exchange rate can be transmitted to an exchange conversion system 520. In an embodiment, the exchange conversion system 520 can include an internal application connected to the server 201. The BPI Smart Contract can connect to the exchange conversion system 520 using APIs. In an embodiment, the exchange conversion system 520 can perform determination of a crypto value and a receiver value by converting the value in the first currency using the first exchange rate and the second exchange rate. The crypto value can be obtained by converting the first currency to a predefined cryptocurrency using the second exchange rate. The receiver value can be obtained by converting the first currency to the second currency using the first exchange rate. In an embodiment, the crypto value and the receiver value obtained can be stored in the BPI Smart Contract 519.

The crypto value and the receiver value are transmitted to a BPI converter 520. In an embodiment, the BPI converter 520 (also referred to as input converting unit) can convert the value in the first currency received from the payment gateway to the crypto value recorded in the BPI Smart Contract 519. The crypto value can be stored in the blockchain network. In an embodiment, a blockchain transaction record 222 begins from conversion of the value to the crypto value, wherein the crypto value is stored in a block in the blockchain network.

In an embodiment, after the conversion, a stable BPI form is created 523. In an embodiment the stable BPI form can include a block created in the blockchain network. The stable BPI form can be considered a digital form containing details of sender, receiver, and payment details, The block is added to record details related to the transfer of the value initiated by the sender. The stable BPI form can include details including but not limited to details of sender including name, address, account and/or wallet, details of receiver including name, address, account and/or wallet, first currency, second currency, first exchange rate, second exchange rate, value for transfer, and receiver value.

On creation of the stable BPI form, routing is performed by the routing control 524 for routing plurality of payments received from plurality of senders profiles to plurality of receiver accounts based on data stored in the operation database 506. On performing routing, queue operation is performed by a collector unit 525 for executing the plurality of payments in an order. Then, each of the payment is transmitted to an output convertor 526.

In an embodiment, the output converter 526 can receive the crypto value of the payment and connect to the exchange conversion system 520 for comparing the crypto value at that time based on a third exchange rate. The third exchange rate is an exchange rate between the crypto-currency and the second currency. In an embodiment, the output converter 526 can adjust the crypto value to match the receiver value based on the third exchange rate. In an embodiment, the output converter 526 is connected to an internal fund account in the blockchain network. The internal fund account can include a balance of cryptocurrency and/or digital currency for performing transaction to a modify number of tokens, thereby adjusting the crypto value to the receiver value.

In an embodiment, the receiver can determine receiving the value in the second currency and/or crypto currency form, using a receiver device. The output converter 526 can transmit the crypto value to the receiver wallet 305 based on the determination of the receiver to receive in crypto currency form. The output converter 526 can convert the crypto value to the receiver value to transmit the receiver value to the receiver bank account 307 based on the determination of the receiver to receive in second currency form.

FIG. 5b illustrates a flow chart of a method of performing a recharge of wallet of the sender in the payment interface.

In an embodiment, the sender can select a recharge 531 option for recharging the wallet with a currency. Then, the sender is directed to a preferred payment mode login 533. The preferred payment mode login 533 can include a login page of a preferred payment mode including but not limited to netbanking. On logging in, a payment is initiated 535 and value transfer 537 is performed to add the value to the wallet 504. The initiated payment 535 for performing the recharge is stored in the payment database 508.

In another embodiment, a method for performing a transaction involving different currencies for transmitting a first digital currency from a sender to a receiver in a second currency can comprise the following steps. In an embodiment, the first digital currency can include a crypto currency, and the second currency can include a fiat currency in the country of the receiver. First, linking a sender profile registered in an interface to a bank account of the sender, and a wallet set up by the interface, by a processor of a sender device. Then, initiating a request for a transfer of a value in a first digital currency from the sender profile to a second currency in a receiver account, by the processor of the sender device. Next, verifying details of the receiver account for processing the request for the transfer, by a processor of a server. Then, initiating the transfer of the first digital currency through a blockchain network for processing the request, by the processor of the server. Then, performing determination of a conversion of the value to the second currency for obtaining a receiver value, and recording the receiver value, by the processor of the server. The conversion can be determined based on extracting a fourth exchange rate for converting the first digital currency to the second currency, by the processor of the server. In an embodiment, the fourth exchange rate can include an exchange rate for converting the first digital currency (cryptocurrency) to the second currency. In an embodiment, the blockchain network can create a stable BPI form using the processor of the server. The stable BPI form can record details of sender, details of receiver, first digital currency, second currency, fourth exchange rate, value for transfer, and receiver value in a block. Then, the method can include performing routing and queue determination for initiating a transfer of the value to the receiver account, by the processor of the server. Next, the value of the first digital currency is adjusted to the receiver value recorded in the stable BPI form by comparing the fourth exchange rate between the crypto currency and the second currency at that time, by an output converter unit in the processor of the server. Finally, an amount equal to the receiver value in one of cryptocurrency and/or second currency is transmitted to one of the receiver crypto wallet and/or the receiver account, by the processor of the server.

In another embodiment, a method for performing a transaction involving different currencies for transmitting a first currency from a sender to a receiver in a second currency can comprise the following steps. In an embodiment, the first currency can include a first currency in the country of the sender, and the second currency can include a fiat currency in the country of the receiver. First, linking a sender profile registered in an interface to a bank account of the sender, and a wallet set up by the interface, by a processor of a sender device. Then, initiating a request for a transfer of a value in a first currency from the sender profile to a second currency in a receiver account, by the processor of the sender device. Next, verifying details of the receiver account for processing the request for the transfer, by a processor of a server. Then, linking a sender profile registered in an interface to a bank account of the sender, and a wallet set up by the interface, by a processor of a sender device. Then, initiating a request for a transfer of a value in a first currency from the sender profile to a second currency in a receiver account, by the processor of the sender device. Then, verifying details of the receiver account for processing the request for the transfer, by a processor of a server. Next, initiating the transfer of the value from the sender profile to the receiver account through a payment gateway, by the processor of the server. Then, connecting the payment gateway of the initiated payment to a blockchain network for processing the request, by the processor of the server. Next, performing determination of a conversion of the value to the second currency for obtaining a receiver value, and recording the receiver value, by the processor of the server. In an embodiment, the conversion is determined based on extracting a first exchange rate for converting the first currency to the second currency, by the processor of the server. Next, converting the value in the first currency received through the payment to a digital form (digital currency) of the first currency, by an input converting unit in the processor of the server. In an embodiment, a stable BPI is created for recording details of sender, details of receiver, first currency, second currency, first exchange rate, value for transfer, and receiver value in a block, by the processor of the server. Next, the processor of the server can perform routing and queue determination for initiating a transfer of an amount equal to the receiver value to the receiver account. Then, the digital currency of the first currency can be adjusted to an amount equal to the receiver value recorded in the stable BPI form by comparing the first exchange rate at that time, by an output converter unit in the processor of the server. Then, converting the digital currency of the first currency to the digital currency of the second currency equal to the receiver value. Finally, transmitting the second currency equal to the receiver value to the receiver account, by the processor of the server.

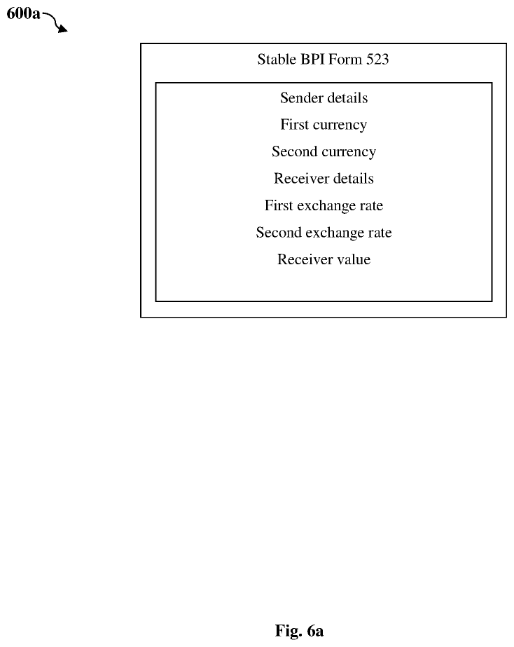

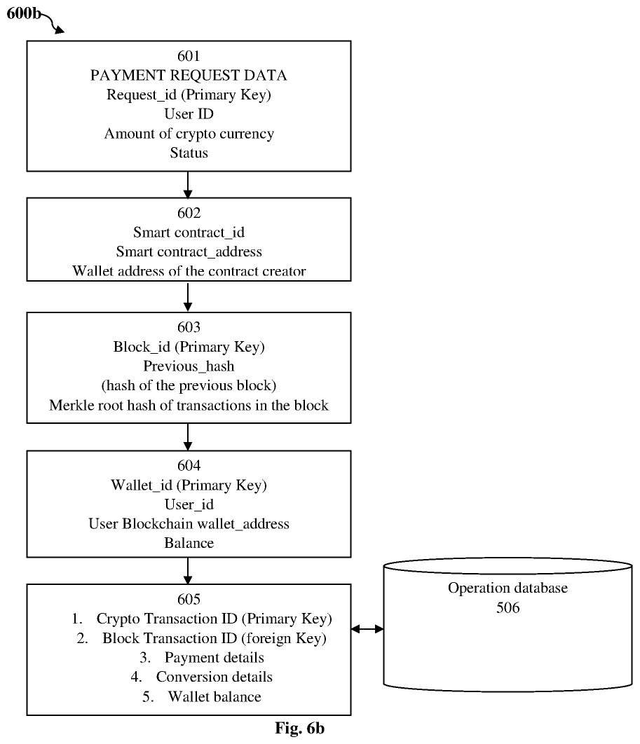

FIG. 6a illustrates the stable BPI form. In an embodiment, the stable BPI form 523 is created as a block in the blockchain network. The stable BPI form can include but not limited to sender details, first currency, second currency, receiver details, first exchange rate, second exchange rate, and receiver value.

FIG. 6b illustrates plurality of tables created in the operation database. In an embodiment, a plurality of tables 601, 602, 603, 604 and 605 are created in the blockchain network during the transfer of the value for a payment of a sender profile and stored in the operation database 506.

The methods according to the above-described example embodiments of the inventive concept may be implemented with program instructions which may be executed by computer or processor and may be recorded in computer-readable media. The media may also include, alone or in combination with the program instructions, data files, data structures, and the like. The program instructions recorded in the media may be designed and configured especially for the example embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to execute one or more software modules to perform the operations of the above-described example embodiments of the inventive concept, or vice versa.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

A main advantage of the present disclosure is that the system and method facilitates performing a transaction involving different currencies.

Another advantage of the present disclosure is that the system and method facilitates instant transaction involving different currencies between users in different countries.

Still another advantage of the present disclosure is that the system and method facilitates economical and secured transaction involving transfer of a value from one currency to another.

Yet another advantage of the present disclosure is that the system and method facilitates faster, secured and instant transfer of different currencies.

Still another advantage of the present disclosure is that the system and method provides creation of a stable BPI form that facilitates secured and consistent cross border payments between countries independent of the requirement of stable coins.

Yet another advantage of the present disclosure is that the system and method provides reduced cost and complexity of transfer of currencies between different currencies as it is efficient and economical to create a single stable BPI form compared to creating a separate stable coin for each country.

Still another advantage of the present disclosure is that the system and method provides increased accessibility, wherein the single stable BPI form would be more accessible to users in all countries, wherein the single stable BPI form prevents creation of a separate wallet or account for stable coin of each country.

Yet another advantage of the present disclosure is that the system and method provides improved interoperability, wherein a single stable BPI form would be more interoperable with other blockchain networks, as it would not be tied to a specific country's fiat currency.

Still another advantage of the present disclosure is that the stable BPI form can be utilized for authenticating and verifying banking payment instructions by banks and other financial institutions as it is secure and reliable.

Yet another advantage of the present disclosure is that the stable BPI form can convert banking payment instructions into a format that can be processed by the blockchain network.

Still another advantage of the present disclosure is that the stable BPI form can facilitate settling blockchain transactions in a timely and efficient manner, without incurring high transaction fees

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

I claim:

1. A method for performing a transaction involving different currencies, comprising the steps of:
linking a sender profile registered in an interface to a bank account of the sender, and a wallet set up by the interface, by a processor of a sender device;
initiating (402) a request for a transfer of a value in a first currency from the sender profile to a second currency in a receiver account, by the processor of the sender device;
verifying (403) details of the receiver account for processing the request for the transfer, by a processor of a server;
initiating the transfer of the value from the sender profile to the receiver account through a payment gateway, by the processor of the server;
connecting the payment gateway of the initiated payment to a blockchain network for processing the request, by the processor of the server;
performing determination of a conversion of the value to the second currency for obtaining a receiver value, and conversion to the crypto currency obtaining a crypto value, and recording the receiver value and the crypto value, by the processor of the server;
wherein the conversion determined based on extracting a first exchange rate for converting the first currency to the second currency, and a second exchange rate for converting the first currency to the cryptocurrency, by the processor of the server;
converting the value in the first currency received through the payment to the crypto value in the crypto currency, by an input converting unit in the processor of the server;
recording details of sender, details of receiver, first currency, second currency, first exchange rate, second exchange rate, value for transfer, and receiver value in a block for creating a stable BPI form, by the processor of the server;
performing routing and queue determination for initiating a transfer of the crypto value to the receiver account, by the processor of the server;
adjusting the crypto value to the receiver value recorded in the stable BPI form by comparing a third exchange rate between the crypto currency and the second currency, by an output converter unit in the processor of the server; and
transmitting an amount equal to the receiver value in one of cryptocurrency and/or second currency to the receiver account, by the processor of the server.

2. The method as claimed in claim 1, wherein the server extracting the first exchange rate and the second exchange rate at a time of start of the day of the transaction.

3. The method as claimed in claim 1, wherein the first currency and the second currency pre-defined by the sender in the interface, using the processor of the sender device.

4. The method as claimed in claim 1, wherein the server connected to an internal fund account including a balance for performing transaction involving crypto currency; and
wherein the internal fund account facilitating adjusting the crypto value to the receiver value based on the third exchange rate at that time.

5. The method as claimed in claim 1, wherein the crypto value equal to the receiver value converted to the receiver value in the second currency, and transmitted to the receiver account.

6. The method as claimed in claim 1, wherein the method including extracting the first exchange rate and the second exchange rate on initiation of the request, by the processor of the sender device; and
transmitting a notification including the first exchange rate and the second exchange rate to the sender profile for receiving confirmation of performing the transfer of the value.

7. The method as claimed in claim 1, wherein details of the initiation of the request including value in a first currency, sender profile, second currency, receiver account stored in a payment database (508); and
the payment database (508) connected to an operation database (506), wherein the operation database (506) connected to the blockchain network.

8. The method as claimed in claim 1, wherein details of the wallet of the sender profile including sender details, balance stored in a blockchain sender database (505); and
the blockchain sender database (505) connected to an operation database (506), wherein the operation database (506) connected to the blockchain network.

9. The method as claimed in claim 1, wherein the first currency can include a fiat currency in the country of the sender and the second currency can include a fiat currency in the country of the receiver.

10. A method for performing a transaction involving different currencies, comprising the steps of:
linking a sender profile registered in an interface to a bank account of the sender, and a wallet set up by the interface, by a processor of a sender device;
initiating (402) a request for a transfer of a value in a first digital currency from the sender profile to a second currency in a receiver account, by the processor of the sender device;
verifying (403) details of the receiver account for processing the request for the transfer, by a processor of a server;
initiating the transfer of the first digital currency through a blockchain network for processing the request, by the processor of the server;
performing determination of a conversion of the value to the second currency for obtaining a receiver value, and recording the receiver value, by the processor of the server;
wherein the conversion determined based on extracting a fourth exchange rate for converting the first digital currency to the second currency, by the processor of the server;
recording details of sender, details of receiver, first digital currency, second currency, fourth exchange rate, value for transfer, and receiver value in a block for creating a stable BPI form, by the processor of the server;
performing routing and queue determination for initiating a transfer of the value to the receiver account, by the processor of the server;
adjusting the value to the receiver value recorded in the stable BPI form by comparing the fourth exchange rate between the first digital currency and the second currency at that time, by an output converter unit in the processor of the server; and
transmitting an amount equal to the receiver value in one of cryptocurrency and/or second currency to the receiver account, by the processor of the server.

11. The method as claimed in claim 10, wherein the first digital currency can include a crypto currency and the second currency can include a fiat currency in the country of the receiver.

12. A system for performing a transaction involving different currencies, comprising:
a sender device (101) including a processor for initiating a request for a transfer of a value in a first currency from a sender profile to a receiver account in a second currency;
wherein the sender device (101) initiating the transfer of the value on verifying details of the receiver account;
a server (201) including a processor (221) connected to the sender device (101), wherein the server device (201) connecting the initiated transfer to a blockchain network;
wherein the server (201) performing a contract based determination of converting the value in the first currency to a value in the second currency for obtaining a receiver value, and to a value in the crypto currency for obtaining a crypto value, and recording the receiver value and the crypto value;
an input converting unit provided in the processor of the server (201) for converting the value in the first currency to the crypto value in the crypto currency;
a stable BPI form creation (209) provided in the server (201) for recording details of sender, details of receiver, first currency, second currency, first exchange rate, second exchange rate, value for transfer, and receiver value in a block to create a stable BPI form;
an output converter unit in the server (201) adjusting the crypto value to the receiver value recorded in the stable BPI form by comparing a third exchange rate between the crypto currency and the second currency; and
a receiver device (303) connected to the server (201) for receiving the receiver value as one of cryptocurrency in a receiver crypto wallet (305) and/or second currency in a receiver bank account (307).
